(19) United States
(12) Patent Application Publication
(10) Pub. No.: US 2008/0069264 A1
(43) Pub. Date: Mar. 20, 2008

(54) Data transmitting apparatus and data receiving apparatus

(76) Inventors: Tomokazu Sada, Osaka (JP); Masaru Fuse, Osaka (JP); Satoshi Furusawa, Osaka (JP); Tsuyoshi Ikushima, Nara (JP); Tomoaki Ohira, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/898,288

(22) Filed: Sep. 11, 2007

(30) Foreign Application Priority Data
Sep. 14, 2006 (JP) 2006-249570

(51) Int. Cl. H04L 25/34

(52) U.S. Cl. 375/286

(57) ABSTRACT

A data communication apparatus which improves security against eavesdropping is provided for secret communication using Y-00 protocol. A multi-level code generation section 111 generates, based on key information 11, a multi-level code sequence 12 in which signal in which a signal level changes so as to be approximately random numbers. A multi-level processing section 112 combines information data 10 and the multi-level code sequence 12, and generates a multi-level signal 13 having a plurality of levels each corresponding to the combination of the information data 10 and the multi-level code sequence 12. A delayed wave generation section 113 generates, based on a delay profile 19, a delayed wave of the multi-level signal 13, combines the generated delayed wave and the multi-level signal 13, and outputs a multipath signal 20. A modulator section 114 modulates the multipath signal 20 in a predetermined modulation method, and outputs a modulated signal 14.

### BACKGROUND OF THE INVENTION

1. Field of the Invention

The present invention relates to an apparatus for performing secret communication in order to avoid illegal eavesdropping and interception by a third party. More specifically, the present invention relates to an apparatus for performing data communication through selecting and setting a specific encoding/decoding (modulation/demodulation) method between a legitimate transmitter and a legitimate receiver.

2. Description of the Background Art

Conventionally, in order to perform communication between specific parties, there has been generally adopted a structure for realizing secret communication by sharing original information (key information) for encoding/decoding between transmitting and receiving ends and by performing, based on the original information, an operation/inverse operation on information data (plain text) to be transmitted in a mathematical manner.

On the other hand, there have been suggested, in recent years, several encryption methods, which positively utilize physical phenomenon occurring in a transmission line. As one of the encryption methods, there is a method called Y-00 protocol performing the secret communication by utilizing a quantum noise generated in an optical transmission line. A conventional data communication apparatus utilizing the Y-00 protocol method is disclosed in Japanese Laid-Open Patent Publication No. 2005-57313 (hereinafter referred to as Patent Document 1).

FIG. 10 is a block diagram showing an exemplary configuration of a conventional data communication apparatus 9 using the Y-00 protocol. As shown in FIG. 10, the conventional data communication apparatus 9 has a configuration in which a transmitting section 901 and a receiving section 902 are connected to each other via an optical transmission line 910. The transmitting section 901 includes a multi-level code generation section 911, a multi-level processing section 912, and a modulator section 913. The receiving section 902 includes a demodulator section 915, a multi-level code generation section 914, and a decision section 916. The transmitting section 901 and the receiving section 902 previously retains key information 91 and key information 96, respectively, which are identical in content to each other.

In the transmitting section 901, the multi-level code generation section 911 generates, based on the key information 91, a multi-level code sequence 92 which is a multi-level pseudo random number series having M values from “0” to “M−1”. The multi-level processing section 912 combines information data 90 and the multi-level code sequence 92, and generates a multi-level signal 93 having levels each corresponding to the combination of the information data 90 and the multi-level code sequence 92. Specifically, the multi-level processing section 912 generates the multi-level signal 93, which is an intensity modulated signal, by using a signal format shown in FIG. 11. In other words, the multi-level processing section 912 divides a signal intensity of the multi-level code sequence 92 into 2M levels. These 2M levels are then made into M combinations each having 2 levels. The multi-level processing section 912 allocates “0” of the information data 90 to one of the 2 levels of each of the M combinations, and allocates “1” of the information data 90 to the other level of the 2 levels of each of the M combinations. The multi-level processing section 912 allocates “0” and “1” of the information data 90 such that the levels corresponding to “0” and “1” are evenly distributed over the whole of the 2M levels.

The multi-level processing section 912 selects, based on a value of the multi-level code sequence 92 having been inputted, one combination from among the M combinations of the levels of the multi-level code sequence 92. Next, the multi-level processing section 912 selects, based on the value of the information data 90, one level of the selected one combination of the levels of the multi-level code sequence 92, and generates the multi-level signal 93 having the selected level. Note that, in Patent Document 1, the multi-level code generation section 911 is described as a transmitting pseudo random number generation section, the multi-level processing section 912 as a modulation method specification section and a laser modulation driving section, the modulator section 913 as a laser diode, the demodulator section 915 as a photo detector, the multi-level code generation section 914 as a receiving pseudo random number generation section, and the decision section 916 as a determination circuit.

FIG. 12 is a schematic diagram illustrating a signal format used for the conventional data communication apparatus 9. With reference to (a), (b), (c), (d), (e), (f), (g) of FIG. 12, a change of a signal will be described in the case of M=4. For example, as shown in (a) and (b) of FIG. 12, in the case where a value of the information data 90 changes “0, 1, 1, 1”, and a value of the multi-level code sequence 92 changes “0, 3, 2, 1”, the multi-level signal 93 is a signal, as shown in FIG. 12(c), having levels each corresponding to the combination of the information data 90 and the multi-level code sequence 92 (see FIG. 12(c)). The modulator section 913 converts the multi-level signal 93 into a modulated signal 94, which is an optical intensity modulated signal, so as to be transmitted via the optical transmission line 910.

Further, in the receiving section 902, the demodulator section 915 performs photoelectric conversion of the modulated signal 94 transmitted via the optical transmission line 910, and outputs a multi-level signal 95. The multi-level code generation section 914 generates, based on the key information 96, a multi-level code sequence 97 which is a multi-level pseudo random number series equal to the multi-level code sequence 92. The decision section 916 determines, based on the multi-level code sequence 97, which one of a combination of signal levels shown in FIG. 11 is used as the multi-level signal 95, and decides, in binary form, two signal levels included in the decided combination.

Specifically, as shown in FIG. 12(e), the decision section 916 sets a decision level in accordance with a value of the multi-level code sequence 97, and decides whether the multi-level signal 95 is larger (upper), or smaller (lower) than the decision level. In this example, decisions made by the decision section 916 are “lower, lower, upper, lower”. Next, the decision section 916 decides that a lower side is “0” and that an upper side is “1” in the case where the multi-level code sequence 97 is even-numbered. The decision section 916 also decides that the lower side is “1” and that the upper side is “0” in the case where the multi-level code sequence 97 is odd-numbered. The decision section 916 then outputs information data 98. In this example, the multi-level code sequence 97 is constituted of “even number, odd number, even number, and odd number”, and thus the information data 98 comes to be “0 1 1 1”, in turn. Although the multi-level signal 95 includes a noise, as long as a signal intensity (an information amplitude) is selected appropriately, it is possible to suppress the noise to the extent that occurrence of an error at the time of a binary decision can be ignored.

Next, possible eavesdropping will be described. An eavesdropper attempts decryption of the information data 90 or the key information 91 from the modulated signal 94 without having key information which is shared between the transmitting and receiving parties. In the case where the eavesdropper performs the binary decision in the same manner as the legitimate receiving party, since the eavesdropper does not have the key information, the eavesdropper needs to attempt decision of all possible values that the key information may take. When this method is used, the number of such attempts increases exponentially with respect to a length of the key information. Accordingly, if the length of the key information is significantly long, the method is not practical.

As an effective method, it is assumed that, with the use of the eavesdropper receiving section 903 as shown in FIG. 10, the eavesdropper attempts decryption of the information data 90 or the key information 91 from the modulated signal 94. In the eavesdropper receiving section 903, the demodulator section 921 demodulates the modulated signal 94 which is obtained after having being branched off from the optical transmission line 910, and reproduces the multi-level signal 95. The multi-level decision section 922 performs a multi-level decision with respect to a multi-level signal 81, and outputs obtained information as a received sequence 82. The decryption processing section 923 performs decryption with respect to the received sequence 82 and attempts identification of the information data 90 or the key information 91. In the case of using a decryption method as above described, if the eavesdropper receiving section 903 can perform the multi-level decision with respect to the received sequence 82 without mistake, the eavesdropper receiving section 903 can decrypt the key information 91 from the received sequence 82 at a first attempt.

However, at the time of photoelectric conversion performed by the demodulator section 921, a shot noise is generated and overlapped on the multi-level signal 81. It is known that the shot noise is inevitably generated based on the principle of quantum mechanics. In the case where an interval (hereinafter referred to as a step width) between signal levels of a multi-level signal is set significantly smaller than a level of the shot noise, a possibility cannot be ignored that the multi-level signal 81 received based on erroneous decision may take various multi-levels other than a correct signal level. Therefore, the eavesdropper needs to perform the decryption processing in consideration of a possibility that the correct signal level may be a value different from that of a signal level obtained through the decision. In such a case, compared to a case without the erroneous decision, the number of attempts, that is, computational complexity required for decryption is increased. As a result it is possible to improve security against the eavesdropping.

Since the noise occurs randomly in the optical transmission line 910 or the demodulator section 921, the eavesdropper may be able to decide incidentally a correct level of the multi-level signal 81 over a long period of time. In this case, the eavesdropper applies a mathematical algorithm for identifying a pseudo random number to the multi-level code sequence 97 which is identified based on the decided level of the multi-level signal 81, whereby the eavesdropper can derive the key information 96 retained by the legitimate receiving party. In this manner, the conventional data communication apparatus 9 is susceptible to eavesdropping performed by the eavesdropper.

### SUMMARY OF THE INVENTION

Therefore, an object of the present invention is to solve the above-described problem, and to provide a data transmitting apparatus and a data receiving apparatus which are capable of effectively increasing computational complexity required for decryption and of enhancing security against eavesdropping without having a complicated hardware configuration.

The present invention is directed to a data transmitting apparatus for encrypting information data by using predetermined key information, and performing secret communication with a receiving apparatus. To attain the above-described object, the data transmitting apparatus of the present invention includes: a multi-level code generation section for generating, based on the predetermined key information, a multi-level code sequence in which a signal level changes so as to be approximately random numbers; a multi-level processing section for combining the information data and the multi-level code sequence, and generating a multi-level signal having a plurality of levels each corresponding to a combination of the information data and the multi-level code sequence; a delayed wave generation section for generating, based on a predetermined delay profile, a multipath signal by combining the multi-level signal and a delayed wave of the multi-level signal; and a modulator section for modulating the multipath signal in a predetermined modulation method, and outputting a modulated signal.

Preferably, the delayed wave generation section includes: a branching section for causing the multi-level signal to branch into a plurality of multi-level signals; a delay section for providing, based on the predetermined delay profile, predetermined delay to at least one multi-level signal of the plurality of multi-level signals caused to branch by the branching section; a level adjustment section for adjusting a level of the at least one multi-level signal, to which the predetermined delay is provided by the delay section, to a predetermined level; and a combining section for combining the plurality of multi-level signals caused to branch by the branching section together, and outputting the multipath signal.

A delay time of the delayed wave defined by the predetermined delay profile is equal to or more than 1 time slot of the multi-level code sequence. Preferably, the delay time of the delayed wave defined by the predetermined delay profile is integer multiple of 1 time slot of the multi-level code sequence.

Further, the present invention is directed to a data receiving apparatus for receiving information data which is encrypted based on predetermined key information, and performing secret communication with a transmitting apparatus. To attain the above-described object, the data receiving apparatus includes: a multi-level code generation section for generating, based on the predetermined key information, a multi-level code sequence in which a signal level changes so as to be approximately random numbers; a demodulator section for demodulating a modulated signal received from the transmitting apparatus in a predetermined demodulation method, and outputting a multipath signal of a multi-level signal having a plurality of levels; an equalizing section for, based on a predetermined delay profile, equalizing the multipath signal, eliminating an element of a delayed wave from the multipath signal, and outputting the multi-level signal; and a decision section for deciding which is the information data from the multi-level signal in accordance with the multi-level code sequence.

Preferably, the equalizing section includes: a Fourier transform section for performing a Fourier transform of the multipath signal, and outputting a first signal spectrum indicative of a frequency spectrum of the multipath signal; a frequency response calculation section for calculating, based on an assumption that the predetermined delay profile corresponds to an impulse response, a frequency response of the impulse response, and outputting a first multipath frequency response; an inverse frequency response calculation section for calculating an inverse response of the first multipath frequency response, and outputting a second multipath frequency response; a multiplication section for multiplying the first signal spectrum by the second multipath frequency response, and outputting a second signal spectrum; and an inverse Fourier transform section for performing an inverse Fourier transform of the second signal spectrum, and outputting the multi-level signal from which the element of the delayed wave included in the multipath is eliminated.

Further, the equalizing section may include: a delay element eliminating section for eliminating the element of the delayed wave from the multipath signal, and outputting the multi-level signal; a branching section for causing the multi-level signal, which is outputted by the delay element eliminating section, to branch; and a delay element estimating section for estimating, based on the multi-level signal having been caused to branch and the predetermined delay profile, the element of the delayed wave which is included in the multipath signal, and providing the element of the delayed wave to the delay element eliminating section.

Further, respective processing executed by respective component parts included the above-described data transmitting apparatus and the data receiving apparatus may be considered as a data transmitting method and a data receiving method each providing a series of processing procedures. That is, the data transmitting method includes: a multi-level code generation step of generating, based on the predetermined key information, a multi-level code sequence in which a signal level changes so as to be approximately random numbers; a multi-level processing step of combining the information data and the multi-level code sequence, and generating a multi-level signal having a plurality of levels each corresponding to a combination of the information data and the multi-level code sequence; a delayed wave generation step of generating, based on a predetermined delay profile, a multipath signal by combining the multi-level signal and a delayed wave of the multi-level signal; and a modulation step of modulating the multipath signal in a predetermined modulation method, and outputting a modulated signal.

Further, the data receiving method includes: a multi-level code generation step of generating, based on the predetermined key information, a multi-level code sequence in which a signal level changes so as to be approximately random numbers; a demodulation step of demodulating a modulated signal received from the transmitting apparatus in a predetermined demodulation method, and outputting a multipath signal of a multi-level signal having a plurality of levels; an equalizing step of, based on a predetermined delay profile, equalizing the multipath signal, eliminating an element of a delayed wave from the multipath signal, and outputting the multi-level signal; and a decision step of deciding which is the information data from the multi-level signal in accordance with the multi-level code sequence.

As above described, according to the data transmitting apparatus of the present invention, the delayed wave generation section generates, based on the delay profile, the multipath signal by combining the multi-level signal and the delayed wave of the multi-level signal. Accordingly, it is possible to significantly increase time required by the eavesdropper for analyzing cipher text, and also possible to realize highly secret data communication. Further, the delay time of the delayed wave is set equal to or more than 1 time slot of the multi-level code sequence, whereby it is possible to remove correlation between the multipath signal and the multi-level signal. Further, the delay time of the delayed wave is set to be integer multiple of 1 time slot of the multi-level code sequence, it is possible to eliminate a level fluctuation caused by a direct wave from the waveform of the multipath signal. Accordingly, the data transmitting apparatus can realize still highly secret data communication.

Further, according to the data receiving apparatus of the present invention, the equalizing section equalizes the multipath signal in accordance with the delay profile, eliminates the element of the delayed wave from the multi-pass signal, and outputs the multi-level signal. Accordingly, it is possible to decode the information data from the modulated signal received from the data transmitting apparatus, whereby the data transmitting apparatus can realize the highly secret data communication.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an exemplary configuration of a data communication apparatus 1 according to one embodiment of the present invention;

FIG. 2 is a diagram showing exemplary temporal waveforms of a multi-level signal 13 and a multipath signal 20;

FIG. 3 is a diagram showing exemplary temporal waveforms of the multi-level signal 13 and the multipath signal 20;

FIG. 4 is a diagram showing exemplary temporal waveforms of the multi-level signal 13 and the multipath signal 20;

FIG. 5 is a block diagram showing an exemplary configuration of a delayed wave generation section 113;

FIG. 6 is a block diagram showing an exemplary configuration of an equalizing section 213;

FIG. 7 is a diagram showing an exemplary signal waveform in the equalizing section 213;

FIG. 8 is a block diagram showing an exemplary configuration of an equalizing section 213a;

FIG. 9 is a diagram illustrating in detail an operation of the equalizing section 213a;

FIG. 10 is a block diagram showing an exemplary configuration of a conventional data communication apparatus 9 using a Y-00 protocol;

FIG. 11 is a diagram showing a signal format of the multi-level signal in the conventional data communication apparatus 9 using the Y-00 protocol; and

FIG. 12 is a schematic diagram illustrating a signal format used for the conventional data communication apparatus 9.

### DESCRIPTION OF THE PREFERRED EMBODIMENTS

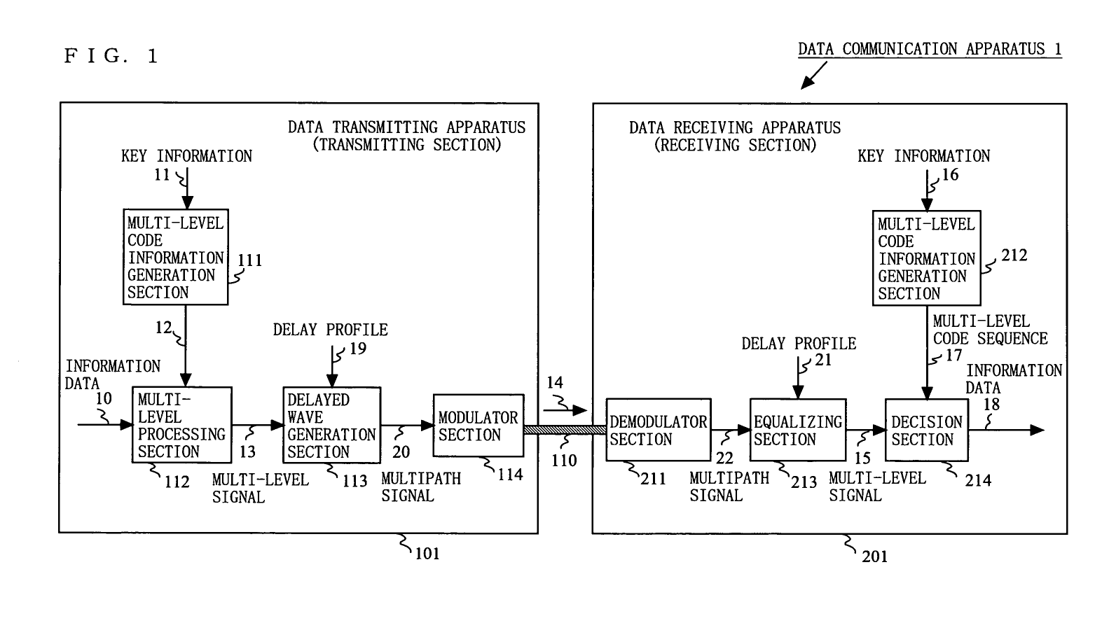

FIG. 1 is a block diagram showing an exemplary configuration of a data communication apparatus 1 according to one embodiment of the present invention. As shown in FIG. 1, the data communication apparatus 1 has a configuration in which a data transmitting apparatus 101 (hereinafter referred to as a transmitting section 101) and a data receiving apparatus 201 (hereinafter referred to as a receiving section 201) are connected to each other via a transmission line 110. The transmitting section 101 includes a multi-level code generation section 111, a multi-level processing section 112, a delayed wave generation section 113, and a modulator section 114. The receiving section 201 includes a demodulator section 211, a multi-level code generation section 212, an equalizing section 213, and a decision section 214. As the transmission line 110, a metal line such as a LAN cable or a coaxial line, or an optical waveguide such as an optical-fiber cable may be used. Further, the transmission line 110 is not limited to a wired cable such as the LAN cable, but can be free space which enables a wireless signal to be transmitted. Note that the transmitting section 101 and the receiving section 201 previously retains key information 11 and key information 16, respectively, which are identical to each other in content.

In the transmitting section 101, the multi-level code generation section 111 generates, based on the key information 11, a multi-level code sequence 12, which is a multi-level pseudo random number series having M values from “0” to “M−1”. To the multi-level processing section 112, information data 10 and the multi-level code sequence 12 are inputted. The multi-level processing section 112 combines, based on a predetermined procedure, the information data 10 and the multi-level code sequence 12, and generates a multi-level signal 13 having levels each corresponding to a combination of the information data 10 and the multi-level code sequence 12.

To the delayed wave generation section 113, the multi-level signal 13 and a delay profile 19 are inputted. The delayed wave generation section 113 generates, based on the delay profile 19, a delayed wave of the multi-level signal 13, combines the generated delayed wave and the multi-level signal 13, and outputs a multipath signal 20. Note that, in the delay profile 19, the delay time of the delayed wave and a signal level of the delayed wave are previously defined. The delayed wave generation section 113 will be described later in detail. To the modulator section 114, the multipath signal 20 is inputted. The modulator section 114 modulates the multipath signal 20 in a predetermined modulation signal, and outputs a modulated signal 14 to the transmission line 110. Here, the predetermined modulation method is typified by an amplitude modulation, a frequency modulation, a phase modulation, optical intensity modulation, and the like, for example.

In the receiving section 201, the demodulator section 211 demodulates the modulated signal 14 transmitted via transmission line 110, in a predetermined demodulation method, and reproduces a multipath signal 22. The predetermined demodulation method is a method corresponding to the modulation method of the modulator section 114. To the equalizing section 213, the multipath signal 22 and a delay profile 21 are inputted. The delay profile 21 is identical to the delay profile 19 used in the transmitting section 101. The equalizing section 213 eliminates (equalizes), based on the delay profile 21, a delay element included in the multipath signal 22, and outputs a multi-level signal 15. The equalizing section 213 will be described later in detail.

The multi-level code generation section 212 generates, based on the key information 16, a multi-level code sequence 17, which is a multi-level pseudo random number series. An operation of the multi-level code generation section 212 is the same as that of the multi-level code generation section 111 included in the transmitting section 101. The decision section 214 decides (binary decision) the multi-level signal 15 in accordance with the multi-level code sequence 17, and outputs a result of the decision as information data 18.

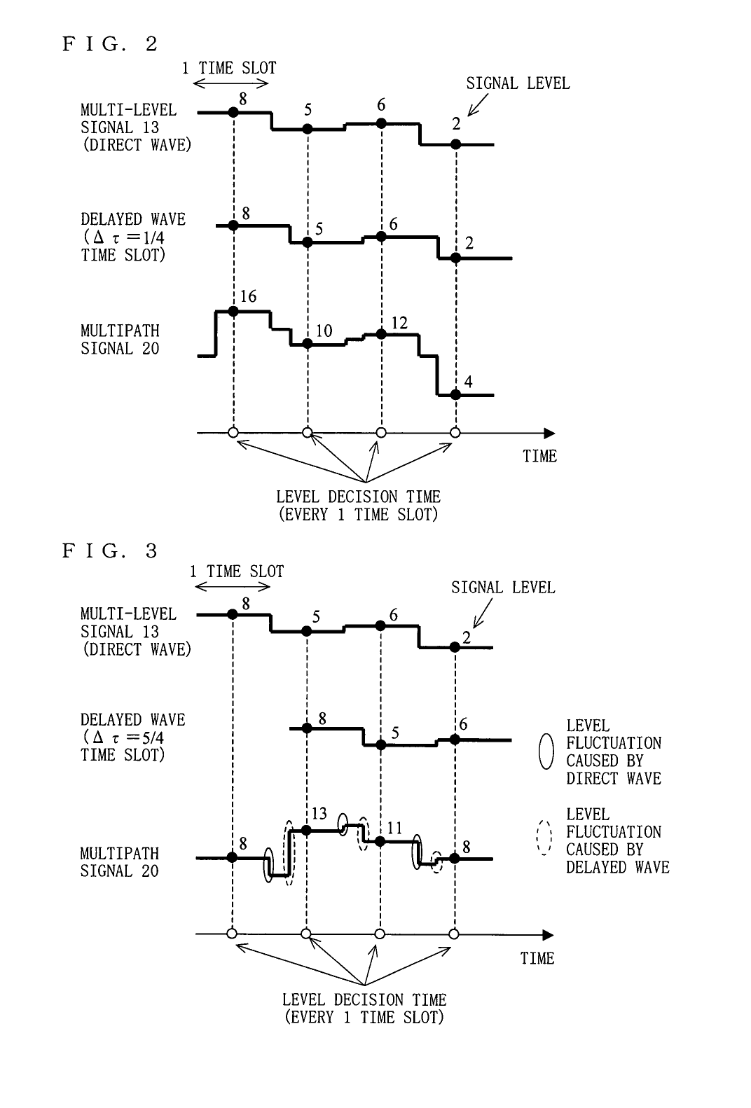

FIG. 2 is a diagram showing exemplary temporal waveforms of the multi-level signal 13 and the multipath signal 20. According to an example shown in FIG. 2, only one delayed wave is combined to the multi-level signal 13, and delay time Δτ of the delayed wave is ¼ time slot. As shown in FIG. 2, the above-described delayed wave interferes with the multi-level signal 13 (a direct wave). Accordingly, in the case where a level of multi-level signal 13 changes 8, 5, 6, 2, levels of the multipath signal 20 received by the eavesdropper at respective level decision times are 16, 10, 12, 4. Therefore, it is difficult for the eavesdropper to identify a correct multi-level code sequence 12 from the received multipath signal 20.

Even in the case where the multipath signal 20 is generated by combining the delayed wave to the multi-level signal 13, each of the levels of the multipath signal 20 at each of the level decision times is twice as high as that of the multi-level signal 13. Therefore, if the eavesdropper halves each of the levels of the multipath signal 20, a possibility cannot be denied that the eavesdropper identifies a correct level of the multi-level signal 13. In order to complicate identification of the multi-level signal 13 by the eavesdropper, the transmitting section 101 maybe caused to perform an operation described below. In this case, inputted to the delayed wave generation section 113 is the delay profile 19 in which the delay time of the delayed wave is defined to be equal to or more than 1 time slot of the multi-level code sequence 12. The delayed wave generation section 113 sets, in accordance with the delay profile 19, the delay time of the delayed wave to equal to or more than 1 time slot of the multi-level code sequence 12 (5/4 time slots in the case of FIG. 3). Accordingly, the transmitting section 101 causes inter-symbol interference in the multipath signal 20, and removes correlation between the multipath signal 20 and the multi-level signal 13, whereby it is possible to realize highly secret data communication.

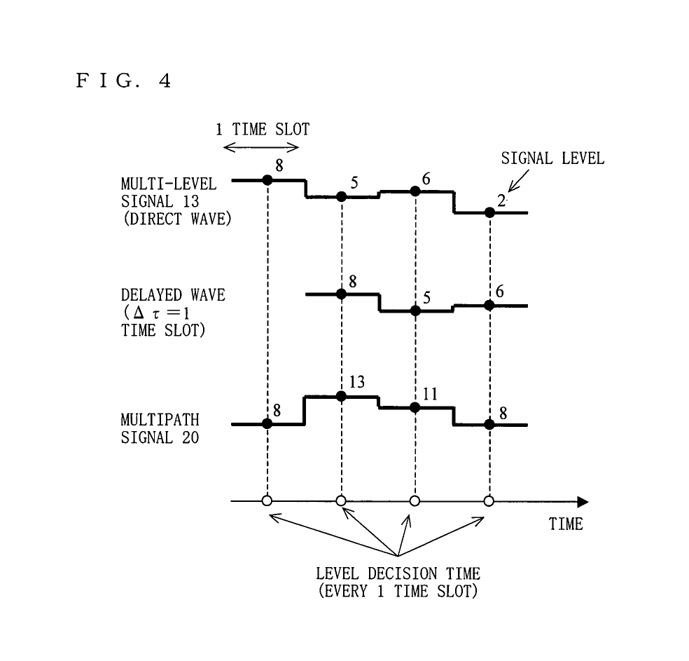

Even in the case where the inter-symbol interference is caused in the multipath signal 20, a level fluctuation caused by the direct wave appears as a waveform in the multipath signal 20, as shown in FIG. 3, and thus a possibility cannot be denied that the eavesdropper identifies the level of the multi-level signal 13 in accordance with the direct wave. Therefore, in order to complicate identification of the multi-level signal 13 by the eavesdropper, the transmitting section 101 may be caused to perform an operation described below. In this case, inputted to the delayed wave generation section 113 is the delay profile 19 in which the delay time of the delayed wave is defined to be integer multiple of 1 time slot of the multi-level code sequence 12. The delayed wave generation section 113 sets, in accordance with the delay profile 19, the delay time of the delayed wave to the multiple of 1 time slot of the multi-level code sequence 12 (1 time slot in the case of FIG. 4). Accordingly, the transmitting section 101 can remove the level fluctuation caused by the direct wave from the waveform of the multipath signal 20, whereby it is possible to realize still highly secret data communication.

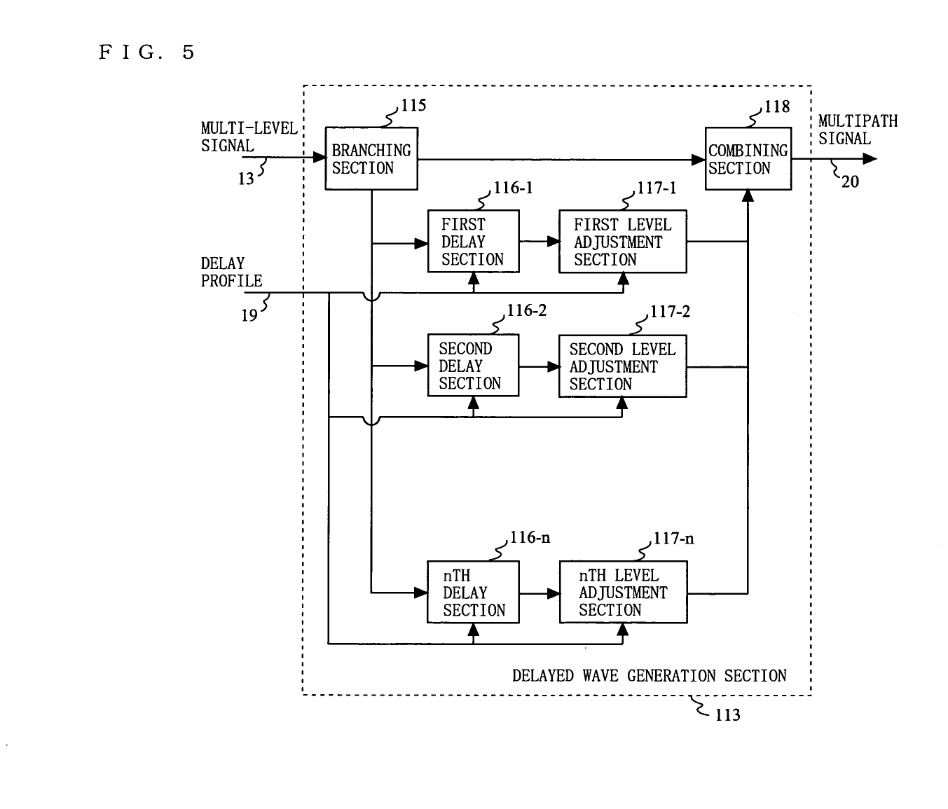

Next, the delayed wave generation section 113 will be described in detail. FIG. 5 is a block diagram showing an exemplary configuration of the delayed wave generation section 113. As shown in FIG. 5, the delayed wave generation section 113 includes a branching section 115, a first to an nth delay sections 116-1 to 116-n, a first to an nth level adjustment sections 117-1 to 117-n, and a combining section 118. Note that n is any integer of 1 or more. An ith delay section 116-i provides a delay time corresponding to an ith delayed wave defined in the delay profile 19 to the multi-level signal 13 so as to generate an ith delayed wave. An ith level adjustment section 117-i provides a level corresponding to the ith delayed wave defined in the delay profile 19 to the ith delayed wave so as to adjust the level of the ith delayed wave. Note that i is any integer between 1 and n, inclusive. The combining section 118 combines the first to the nth delayed waves, whose levels are respectively adjusted, and the multi-level signal 13, and then outputs the multipath signal 20. In accordance with the above-described configuration, the delayed wave generation section 113 can generate the multipath signal 20 from the multi-level signal 13 in accordance with the delay profile 19.

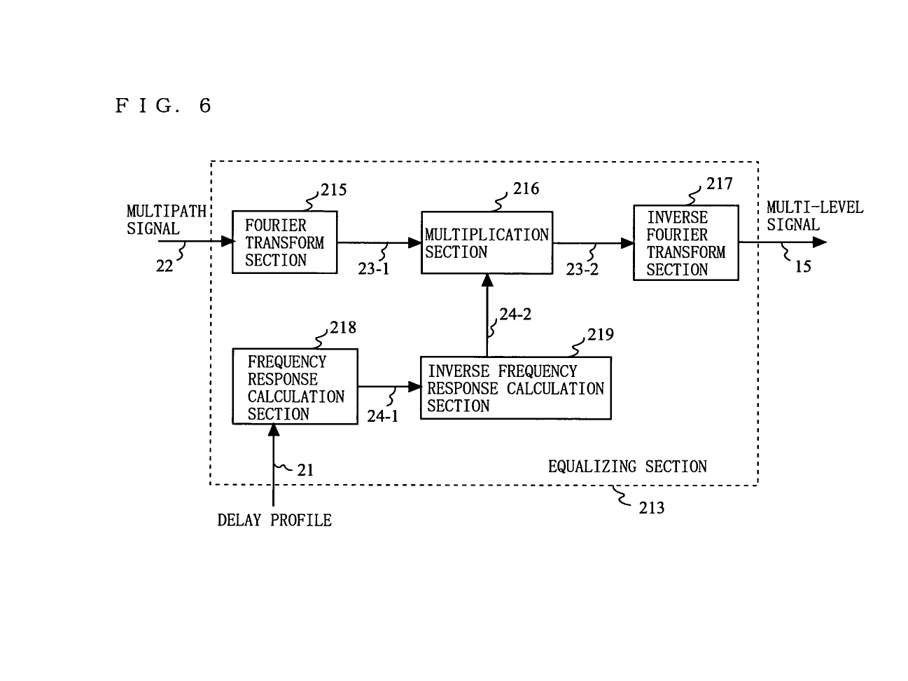

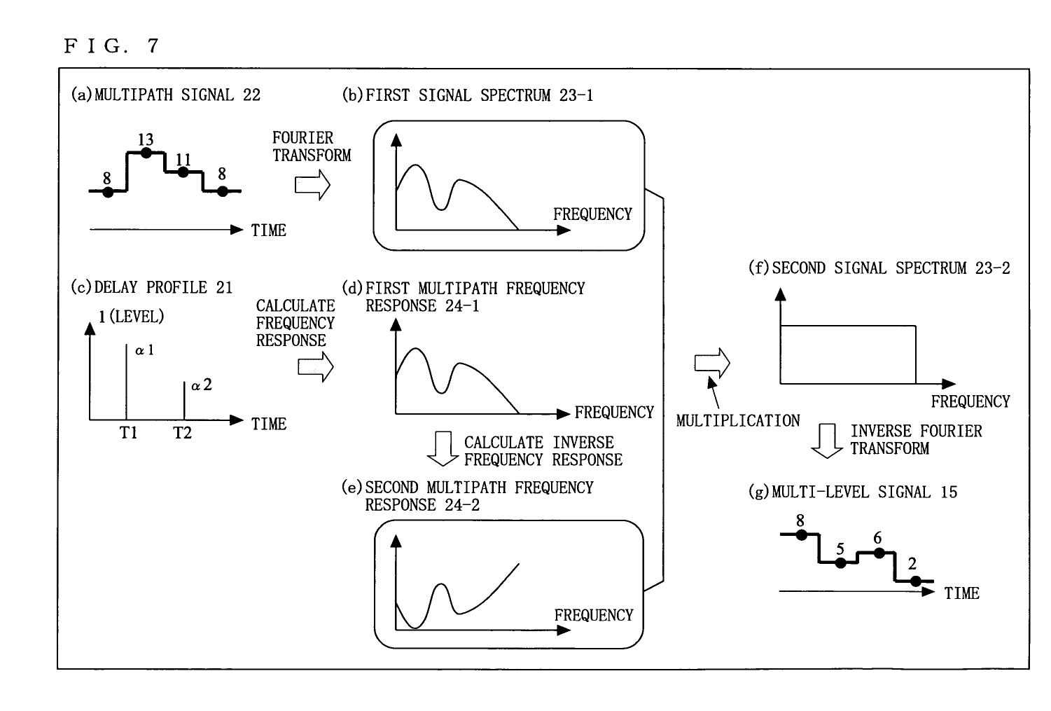

Next, the equalizing section 213 will be described in detail. FIG. 6 is a block diagram showing an exemplary configuration of the equalizing section 213. As shown in FIG. 6, the equalizing section 213 includes a Fourier transform section 215, an multiplication section 216, an inverse Fourier transform section 217, a frequency response calculation section 218, and an inverse frequency response calculation section 219. Hereinafter, with reference to a signal form shown in FIG. 7, an operation of the equalizing section 213 will be described. FIG. 7 is a diagram showing an exemplary signal form in the equalizing section 213. In the equalizing section 213, the multipath signal 22 is inputted to the Fourier transform section 215 from the demodulator section 211 (see FIG. 7(a)). The Fourier transform section 215 performs Fourier transform of the multipath signal 22, and generates a first signal spectrum 23-1 (see FIG. 7(b)). That is, the first signal spectrum 23-1 is a frequency spectrum of the multipath signal 22.

To the frequency response calculation section 218, the delay profile 21 is inputted (see FIG. 7(c)). The frequency response calculation section 218 regards the delay profile 21 as an impulse response, and performs Fourier transform of the delay profile 21, thereby outputting a first multipath frequency response 24-1 (see FIG. 7(d)). The inverse frequency response calculation section 219 calculates an inverse response of the first multipath frequency response 24-1, and outputs a second multipath frequency response 24-2 (see FIG. 7(e)). The multiplication section 216 multiplies the first signal spectrum 23-1 by the second multipath frequency response 24-2, and outputs a second signal spectrum 23-2 (see FIG. 7(f)). The inverse Fourier transform section 217 performs an inverse Fourier transform of the second signal spectrum 23-2, and outputs the multi-level signal 15 from which the delay element is eliminated (see FIG. 7(g)). In accordance with the above-described configuration, the equalizing section 213 eliminates (equalizes), based on the delay profile 21, the delay element included in the multipath signal 22, thereby obtaining the multi-level signal 15.

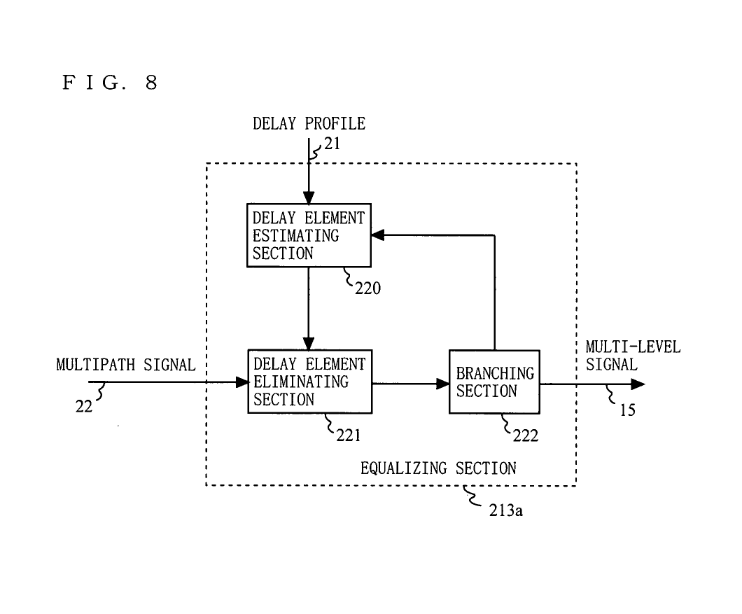

Further, the equalizing section 213 may be configured in the same manner as an equalizing section 213a shown in FIG. 8. FIG. 8 is a block diagram showing an exemplary configuration of the equalizing section 213a. As shown in FIG. 8, the equalizing section 213a includes a delay element estimating section 220, a delay element eliminating section 221, and a branching section 222. The delay element eliminating section 221 subtracts the delay element estimated by the delay element estimating section 220 from the multipath signal 22, and outputs the multi-level signal 15 from which the delay element is eliminated. The branching section 222 causes the multi-level signal 15, which is outputted from the delay element eliminating section 221, to branch. The delay element estimating section 220 estimates, based on the multi-level signal 15 caused to branch by the branching section 222 and the delay profile 21, the delay element included in the multi-level signal 15.

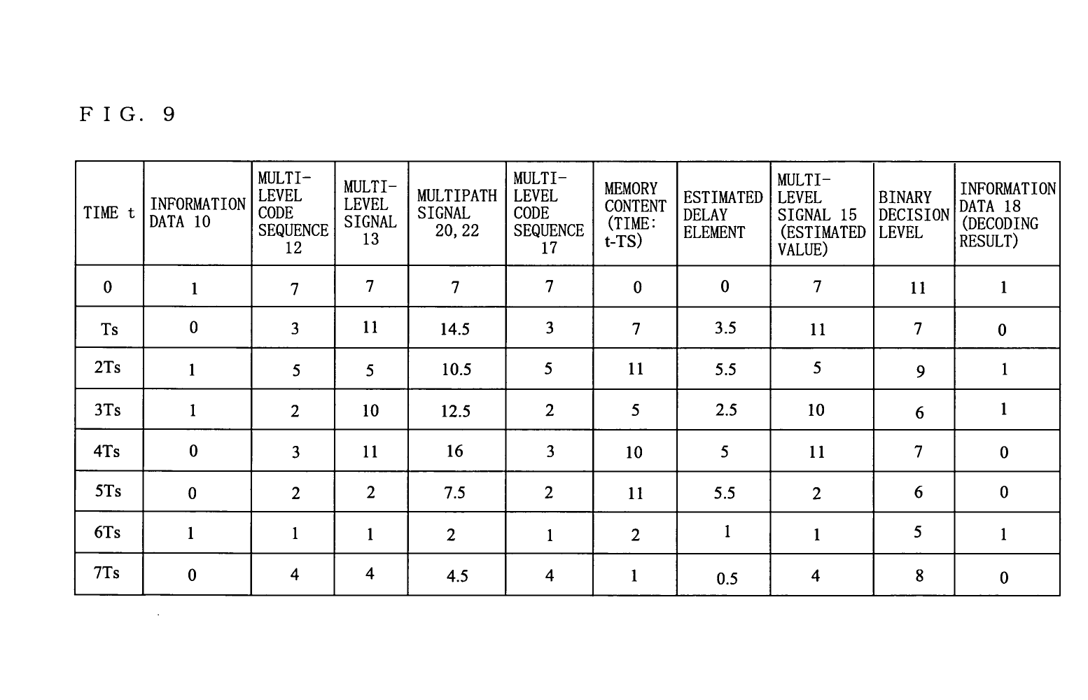

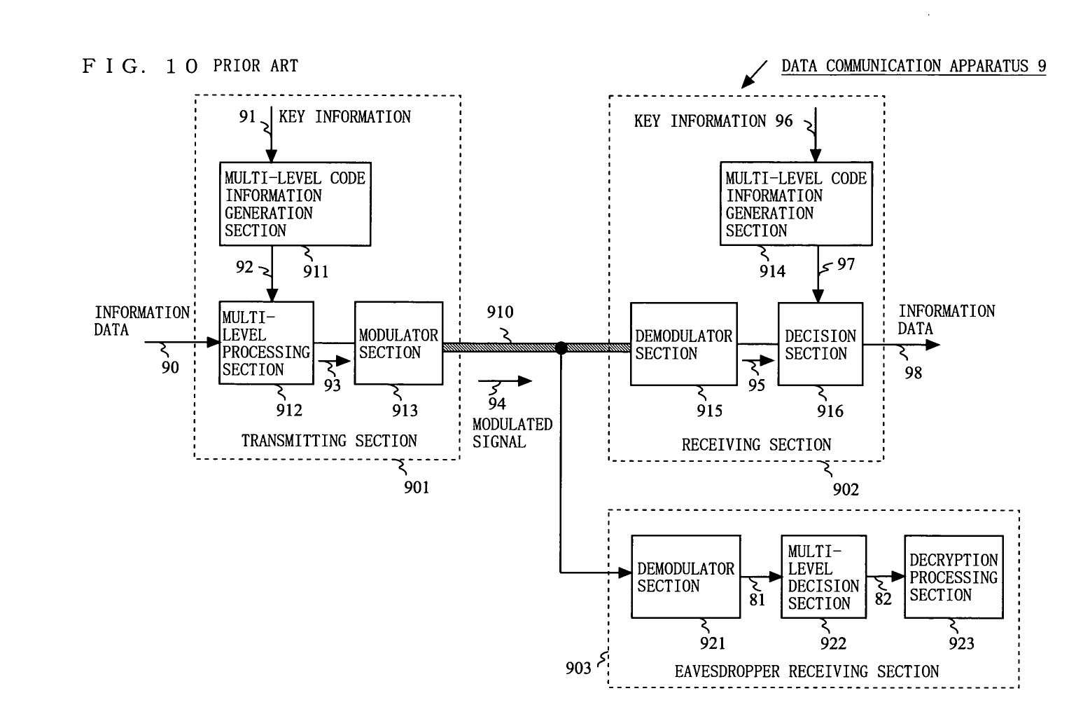

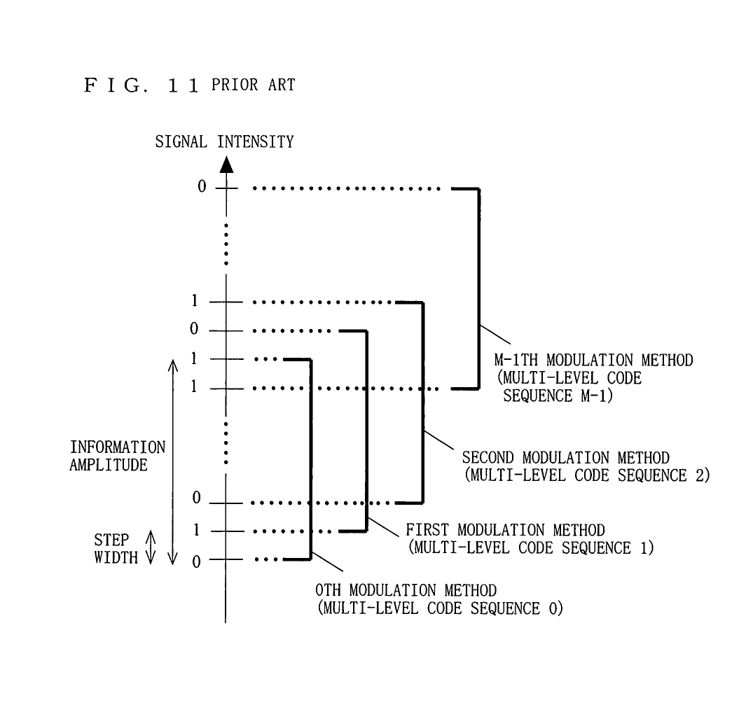

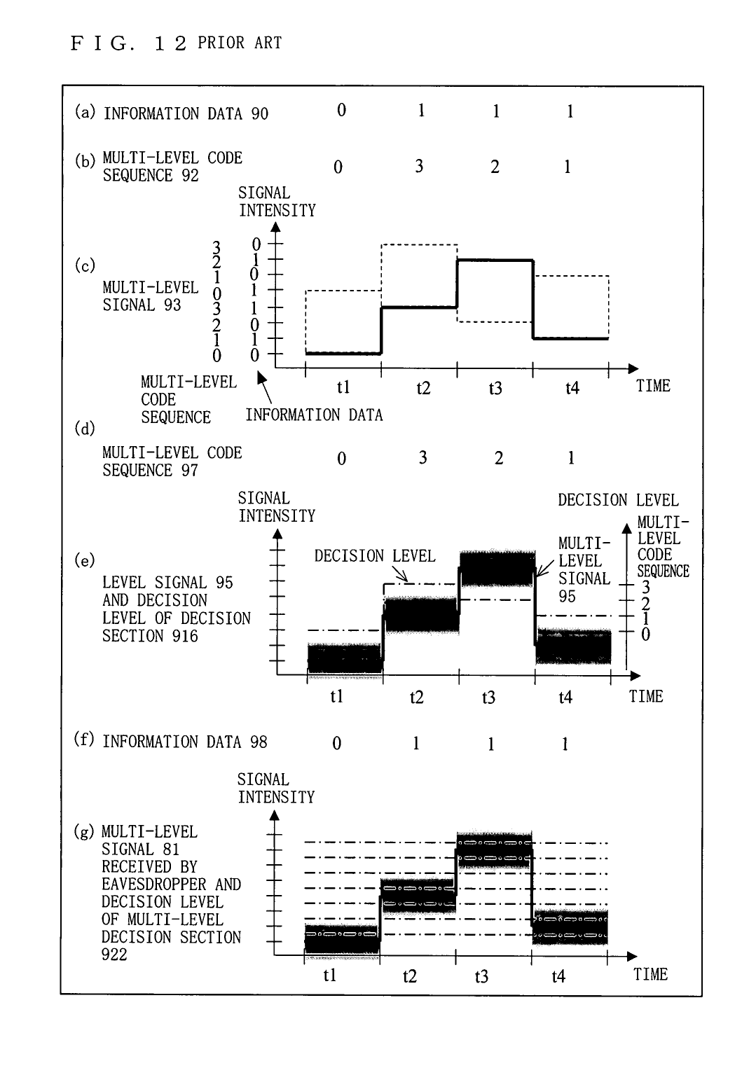

With reference to FIG. 9, an operation of the equalizing section 213a will be described in detail. FIG. 9 is a diagram illustrating, in detail, the operation of the equalizing section 213a. As shown in FIG. 9, assuming that the information data 10 is constituted of values of “1, 0, 1, 1, 0, 0, 1”, and that the multi-level code sequence 12 is constituted of values of “7, 3, 5, 2, 3, 2, 1, 4”, then the multi-level signal 13 is constituted of values of “7, 11, 5, 10, 11, 2, 1, 4”. Further, assuming that each of the delay profile 19 and the delay profile 21 (having impulse response of a signal level of 1) is constituted of the direct wave having level 1 at the time of the delay time τ=0 and the delayed wave having level 0.5 at the time of the delay time τ=Ts (Ts is equivalent to 1 time slot), then each of the multipath signals 20 and 22 is constituted of values of “7, 14.5, 10.5, 12.5, 16, 7.5, 2, 4.5”.

Based on the delay profile 21, the delay element estimating section 220 stores, in a memory or the like, a previous level of the multi-level signal 15 from a current time back to a maximum delay time (Ts in the case of this assumptive example) of the delayed wave. The previous signal level of the multi-level signal 15 stored in the memory is used to obtain the delay element. That is, each of the levels of the delayed waves defined in the delay profile 21 is multiplied by the previous level of the multi-level signal 15 from the current time back to the delay time, and a total sum of respective multiplication results amounts to the delay element.

First, a case of time t=0 will be considered. Since a signal is not transmitted in the past before t=0 (since a waveform of level 0 is stored in the memory), a value of the delay element estimated by the delay element estimating section 220 is 0. The delay element eliminating section 221 subtracts the delay element estimated by the delay element estimating section 220 from the multipath signal 22. In this case, the level of the multi-level signal 15 at time t=0 is represented by an equation of “7-0”, which is equal to 7. This level of the multi-level signal 15 is inputted to the decision section 214, whereby the information data “1” at time t=0 is decoded.

Next, a case of time t=Ts will be considered. In the memory of the delay element estimating section 220, the previous level of the multi-level signal from the current time back to the maximum delay time Ts, that is, the multi-level signal “7” at time t=0 is stored. Therefore, the estimate value of the delay element is obtained by multiplying the multi-level signal “7” by the level of the delayed wave “0.5” at the time of delay time t=Ts (defined for the delay profile). That is, the estimate value of the delay element comes to “3.5”. Next, the delay element eliminating section 221 subtracts, from the multipath signal “14.5” at the time t=Ts, the estimate value “3.5” of the delay element at the same time t=Ts. As a result, the multi-level signal 15 outputted from the delay element eliminating section 221 comes to “11”. Processing thereafter is performed in the same manner as the case of the time t=0, and accordingly, “0” is decoded as the information data 18 at the time t=Ts. The receiving section 201 performs the above-described process with respect to time t=2 Ts, 3 Ts and thereafter, in a similar manner, thereby decoding the information data 18 from the multi-level signal 15 from which the delay element is eliminated.

As above described, in the data transmitting apparatus 101 according to the one embodiment of the present invention, the delayed wave generation section 113 generates, based on the delay profile 19, the multipath signal 20 by combining the multi-level signal 13 and the delayed wave of the multi-level signal 13, whereby time required by the eavesdropper for analyzing cipher text is significantly increased. Accordingly, highly secret data communication can be realized. Further, the delay time of the delayed wave is set equal to or more than 1 time slot of the multi-level code sequence 12, whereby it is possible to remove correlation between the multipath signal 20 and the multi-level signal 13. Further, the delay time of the delayed wave is set to integer multiple of 1 time slot of the multi-level code sequence 12, whereby the level fluctuation caused by the direct wave can be eliminated from the waveform of the multipath signal 20. Accordingly, the data transmitting apparatus 101 can realize still highly secret data communication.

Further, in the data receiving apparatus 201 according to the one embodiment of the present invention, the equalizing section 213 performs equalization of the multipath signal 22 in accordance with the delay profile 21, eliminates an element of the delayed wave from the multipath signal 22, and outputs the multi-level signal 15. Accordingly, it is possible to decode the information data 18 from the modulated signal 14 received from the data transmitting apparatus 101. Therefore, the data receiving apparatus 201 can realize highly secret data communication.

Note that respective processing procedures performed by respective component parts of the data transmitting apparatus 101 and the data receiving apparatus 201 according to the above-describe embodiments may be considered as a data transmitting method and a data receiving method. Further, the respective processing procedures may be realized by causing a CPU to interpret and execute predetermined program data, which is capable of executing the above-described procedures and stored in a storage device (such as a ROM, a RAM, or a hard disk, and the like). In this case, the program data may be executed after the same is stored in the storage device via a storage medium, or may be directly executed from the storage medium. Here, the storage medium includes a ROM, a RAM, a semiconductor memory such as a flash memory, a magnetic disk memory such as a flexible disk and a hard disk, an optical disk such as a CD-ROM, a DVD, and a BD, a memory card, and the like. Further, the storage medium as mentioned herein is a notion including a communication medium such as a telephone line and a carrier line.

The data communication apparatus according to the present invention is useful as a safe secret communication apparatus which is insusceptible to eavesdropping, interception, or the like.

While the invention has been described in detail, the foregoing description is in all aspects illustrative and not restrictive. It is understood that numerous other modifications and variations can be devised without departing from the scope of the invention.

What is claimed is:

1. A data transmitting apparatus for encrypting information data by using predetermined key information, and performing secret communication with a receiving apparatus, the data transmitting apparatus comprising:
a multi-level code generation section for generating, based on the predetermined key information, a multi-level code sequence in which a signal level changes so as to be approximately random numbers;
a multi-level processing section for combining the information data and the multi-level code sequence, and generating a multi-level signal having a plurality of levels each corresponding to a combination of the information data and the multi-level code sequence;
a delayed wave generation section for generating, based on a predetermined delay profile, a multipath signal by combining the multi-level signal and a delayed wave of the multi-level signal; and
a modulator section for modulating the multipath signal in a predetermined modulation method, and outputting a modulated signal.

2. The data transmitting apparatus according to claim 1, wherein
the delayed wave generation section includes:
a branching section for causing the multi-level signal to branch into a plurality of multi-level signals;
a delay section for providing, based on the predetermined delay profile, predetermined delay to at least one multi-level signal of the plurality of multi-level signals caused to branch by the branching section;
a level adjustment section for adjusting a level of the at least one multi-level signal, to which the predetermined delay is provided by the delay section, to a predetermined level; and
a combining section for combining the plurality of multi-level signals caused to branch by the branching section together, and outputting the multipath signal.

3. The data transmitting apparatus according to claim 1, wherein a delay time of the delayed wave defined by the predetermined delay profile is equal to or more than 1 time slot of the multi-level code sequence.

4. The data transmitting apparatus according to claim 1, wherein a delay time of the delayed wave defined by the predetermined delay profile is integer multiple of 1 time slot of the multi-level code sequence.

5. A data receiving apparatus for receiving information data which is encrypted based on predetermined key information, and performing secret communication with a transmitting apparatus, the data receiving apparatus comprising:
a multi-level code generation section for generating, based on the predetermined key information, a multi-level code sequence in which a signal level changes so as to be approximately random numbers;
a demodulator section for demodulating a modulated signal received from the transmitting apparatus in a predetermined demodulation method, and outputting a multipath signal of a multi-level signal having a plurality of levels;
an equalizing section for, based on a predetermined delay profile, equalizing the multipath signal, eliminating an element of a delayed wave from the multipath signal, and outputting the multi-level signal; and
a decision section for deciding which is the information data from the multi-level signal in accordance with the multi-level code sequence.

6. The data receiving apparatus according to claim 5, wherein
the equalizing section includes:
a Fourier transform section for performing a Fourier transform of the multipath signal, and outputting a first signal spectrum indicative of a frequency spectrum of the multipath signal;
a frequency response calculation section for calculating, based on an assumption that the predetermined delay profile corresponds to an impulse response, a frequency response of the impulse response, and outputting a resultant of calculation as a first multipath frequency response;
an inverse frequency response calculation section for calculating an inverse response of the first multipath frequency response, and outputting a second multipath frequency response;
a multiplication section for multiplying the first signal spectrum by the second multipath frequency response, and outputting a second signal spectrum; and
an inverse Fourier transform section for performing an inverse Fourier transform of the second signal spectrum, and outputting the multi-level signal from which the element of the delayed wave included in the multipath is eliminated.

7. The data receiving apparatus according to claim 5, wherein
the equalizing section includes:
a delay element eliminating section for eliminating the element of the delayed wave from the multipath signal, and outputting the multi-level signal;
a branching section for causing the multi-level signal, which is outputted by the delay element eliminating section, to branch; and
a delay element estimating section for estimating, based on the multi-level signal having been caused to branch and the predetermined delay profile, the element of the delayed wave which is included in the multipath signal, and providing the element of the delayed wave to the delay element eliminating section.

8. A data transmitting method for encrypting information data by using predetermined key information, and performing secret communication with a receiving apparatus, the data transmitting method comprising:
a multi-level code generation step of generating, based on the predetermined key information, a multi-level code sequence in which a signal level changes so as to be approximately random numbers;
a multi-level processing step of combining the information data and the multi-level code sequence, and generating a multi-level signal having a plurality of levels each corresponding to a combination of the information data and the multi-level code sequence;
a delayed wave generation step of generating, based on a predetermined delay profile, a multipath signal by combining the multi-level signal and a delayed wave of the multi-level signal; and
a modulation step of modulating the multipath signal in a predetermined modulation method, and outputting a modulated signal.

9. A data receiving method for receiving information data which is encrypted based on predetermined key information, and performing secret communication with a transmitting apparatus; the data receiving method comprising:
a multi-level code generation step of generating, based on the predetermined key information, a multi-level code sequence in which a signal level changes so as to be approximately random numbers;
a demodulation step of demodulating a modulated signal received from the transmitting apparatus in a predetermined demodulation method, and outputting a multipath signal of a multi-level signal having a plurality of levels;
an equalizing step of, based on a predetermined delay profile, equalizing the multipath signal, eliminating an element of a delayed wave from the multipath signal, and outputting the multi-level signal; and
a decision step of deciding which is the information data from the multi-level signal in accordance with the multi-level code sequence.
